(19) United States
(12) Patent Application Publication
(10) Pub. No.: US 2021/0199069 A1
(43) Pub. Date: Jul. 1, 2021

(54) Self-Cleaning Combustion Engine Window

(71) Applicant: Wisconsin Alumni Research Foundation, Madison, WI (US)

(72) Inventor: Scott Sanders, Middleton, WI (US)

(21) Appl. No.: 15/734,052

(22) PCT Filed: May 31, 2019
(86) PCT No.: PCT/US2019/034861

§ 371 Date: Dec. 1, 2020

Related U.S. Application Data
(60) Provisional application No. 62/681,485, filed on Jun. 6, 2018.

(51) Int. Cl. F02F 1/18; F01M 1/08; F02D 33/00; G01N 21/31

(52) U.S. Cl. CPC F02F 1/18; F01M 1/08; F16N 2250/34; G01N 21/31; F01M 2001/083; F02D 33/00

(57) ABSTRACT

Improved combustion monitoring in an internal combustion engine is provided by an optical port passing through a side wall of the combustion chamber where a front surface of the port may be cleaned by wiping action of piston rings passing across that surface. A thin film of oil distributed by the rings reduces the adhesion of fouling deposits.

### CROSS REFERENCE TO RELATED APPLICATION

This application claims the benefit of U.S. provisional 62/681,485 filed Jun. 6, 2018, which is hereby incorporated by reference.

### BACKGROUND OF THE INVENTION

The present invention relates to internal combustion engines and in particular to a system for precise measurement of combustion for engine control.

Modern internal combustion engines provide sophisticated control systems for managing combustion to increase engine efficiency and/or reduce undesired emissions. Such control systems may adjust spark timing, fuel timing and amount, and valve timing to adjust combustion conditions within the engine to a target state under varying loads, fuel grades, and environmental conditions.

The desired target state for optimal combustion is unstable and for this reason the control system must constantly monitor the combustion process as it evolves to recompute the control outputs. For this purpose, it is important to have accurate knowledge of combustion temperature and other features of the combustion gas within the combustion chamber. Such information is difficult to obtain. Experimental internal combustion engines for research may provide windows into the combustion chamber that allow direct monitoring of the combustion process; however, windows are subject to fouling by soot and the like and require regular cleaning. This requirement for regular cleaning makes such combustion chamber windows largely impractical for commercial engines.

### SUMMARY OF THE INVENTION

The present invention places combustion chamber windows in the cylinder wall at locations where they may be wiped by the piston rings of the piston to remove obscuring particulate matter. Because windows placed in this position are inevitably coated with contaminated oil distributed over the cylinder walls by the piston rings, the cylinder walls would appear to be a poor candidate for window location. The inventors, however, have determined that a controlled thin layer of contaminated oil permits sufficient transmission for absorption spectrometry. The result is a system that can provide real-time combustion gas analysis suitable for long-term use in commercial engines.

Specifically then, the present invention provides an internal combustion engine having a combustion chamber providing a cylindrical passageway terminating at a cylinder head. A piston is sized to slidably reciprocate within the cylindrical passageway and includes at least one piston ring encircling the piston and elastically biased outward to engage inner walls of the cylindrical passageway with movement of the piston. The combustion chamber includes at least one window on the inner wall of the cylindrical passageway providing a passage of light into and out of the combustion chamber through the inner wall, an inner surface of the window positioned proximate to the inner surface to be cleared of optically obscuring contamination by movement of the piston ring thereacross with reciprocation of the piston.

It is thus a feature of at least one embodiment of the invention to provide a window into the combustion chamber, for optical measurements of combustion gases, so that the window is resistant to long-term fouling and thus suitable for standard commercial engines.

The internal combustion engine may further include a lubrication system delivering oil through openings in the piston to be distributed over the inner wall of the cylindrical passageway and the window with movement of the piston.

It is thus a feature of at least one embodiment of the invention to use an oil layer to protect the window against initial adhesion of damaging fouling deposits.

The window may be offset inward from the inner wall of the cylindrical chamber.

It is thus a feature of at least one embodiment of the invention to preserve a protective layer of oil during initial engine operation and to accommodate cylinder wear. The inventor has determined that a thin layer of dirty oil can be accommodated by the optical measurements thus permitting a longer-lived system.

The window may be offset inward by less than 150 micrometers and in some embodiments by less than 50 micrometers.

It is thus a feature of at least one embodiment of the invention to position the window close enough to the piston rings so that the piston rings remove fouling deposits leaving only a thin layer of oil.

The internal combustion engine may include at least one of an electronic light sensor and electronic light emitter positioned outside of the combustion chamber to receive light through the at least one window. The engine may include an optical spectroscope communicating with at least one of the electronic light sensor and electronically emitter to provide a measure of the optical absorption by gases within the combustion chamber.

It is thus a feature of at least one embodiment of the invention to permit spectrographic analysis of combustion gases such as can yield a variety of measurements including gas temperature.

The optical spectroscope may measure absorption of water vapor within a temperature range of a combustion engine.

It is thus a feature of at least one embodiment of the invention to permit the measurement of water vapor as a proxy for combustion temperature.

The engine may include a controller for receiving a temperature measurement from the optical spectroscope to control the fuel delivery system according to a stored program optimizing operation of the internal combustion engine for at least one of fuel efficiency, power, and reduced emissions.

It is thus a feature of at least one embodiment of the invention to provide more precise engine control possible by direct measurement of combustion gases.

The window may have a diameter of less than three millimeters.

It is thus a feature of at least one embodiment of the invention to provide a ready integration into the combustion cylinder wall with minimal structural effect and required pressure resistance.

The window may have a surface facing inward to the combustion chamber that is a sector of the cylinder aligned with and conforming to a cylinder defining the cylindrical passageway.

It is thus a feature of at least one embodiment of the invention to provide a window optimized for a broad area clearance by passing piston rings.

The internal combustion engine may include a window constructed of a material selected from the group consisting of silica and sapphire.

It is thus a feature of at least one embodiment of the invention to provide long life window materials resistant to frictional abrasion.

The piston may provide a piston pin extending along an axis to provide a pivoting joint with a connecting rod communicating between the piston and a crankshaft, and the window may be positioned on the inner wall of the cylindrical passageway within 45 degrees of a vertical plane of the axis of the piston pin as measured about an axis of symmetry of the cylindrical passageway. In addition, or alternatively, the window may be positioned above the bottom dead center location and below a midpoint between the top dead center and bottom dead center positions.

It is thus a feature of at least one embodiment of the invention to position the window at a region of minimized cylinder wear to maximize window life.

These particular objects and advantages may apply to only some embodiments falling within the claims and thus do not define the scope of the invention.

### BRIEF DESCRIPTION OF THE DRAWINGS

FIG. 1 is a block diagram of an engine according to one embodiment of the invention providing one or more windows in the cylinder wall of the engine permitting absorption spectrometry through those windows;

FIG. 2 is an elevational cross-section through one window in the cylinder wall and through the piston of FIG. 1, the piston providing multiple piston rings that sweep across the window area;

FIG. 3 is an enlarged view of the window area of FIG. 2 showing the close proximity of the window to the cylinder wall surface in an embodiment providing both a light emitter and light receiver behind one window;

FIG. 4 is a cross-sectional view along the horizontal plane through the windows of FIGS. 2 and 3 showing a curvature of the window to promote close clearance with the piston; and

FIG. 5 is an elevational cross-sectional view along the plane of FIGS. 2 and 3 showing an alternative embodiment with two opposed windows associated with a light emitter and light transmitter respectively.

### DETAILED DESCRIPTION OF THE PREFERRED EMBODIMENT

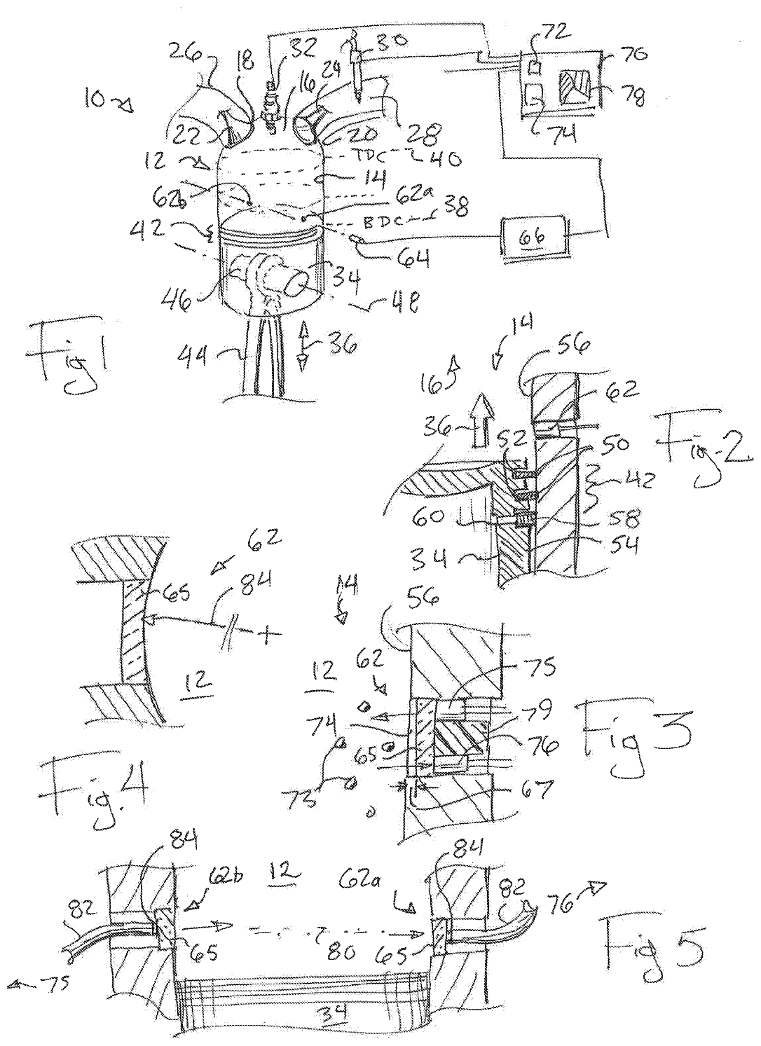

Referring now to FIG. 1, a combustion engine 10 may provide one or more combustion chambers 12, for example, formed out of steel or cast iron and providing a cylindrical passageway 14 terminating at its upper end with a cylinder head 16.

The cylinder head 16 may provide for valve openings 18 and 20 having corresponding valves 22 and 24. Valve 22 may control the exit of exhaust gases from the combustion chamber 12 through an exhaust manifold 26. Valve 24 may control the receipt of air and fuel to an intake manifold 28, the latter including a fuel injector 30 of conventional design. Alternatively, it will be appreciated that the fuel injector 30 may be placed directly in the cylinder head 16 to inject fuel directly into the combustion chamber 12.

For gasoline engines, the cylinder head 16 may support a spark plug 32 having electrodes exposed within the combustion chamber 12; however, the present invention is equally applicable to diesel engines where the spark plug 32 is not required.

A piston 34, having a generally cylindrical shape, fits within the cylindrical passageway 14 to slide closely therein in a reciprocating motion as indicated by arrow 36. This reciprocating motion moves the piston 34 between bottom dead center 38 and top dead center 40 positions. An upper edge of the piston 34 includes a ring pack 42 being a set of circular metal rings radially compressed to fit in corresponding slots of the piston 34 opening radially outward from the cylindrical piston wall. The rings of the ring pack 42 expand outward to form a tight seal between the piston 34 and the inner wall of the cylindrical passageway 14.

The piston 34 may provide a wrist pin 46 attaching the piston 34 to a connecting rod, 44 the latter attached to a crankshaft (not shown). The wrist pin 46 allows the piston 34 to pivot with respect to the connecting rod 44 along a pivot axis 48 accommodating the eccentric movement of a crankshaft attachment while allowing the piston 34 to move in a substantially straight line up and down.

Referring now also to FIG. 2, the piston ring pack 42 will typically include one or more compression rings 50 passing circumferentially around the piston 34 and coaxially aligned with a center axis of the piston 34 being an axis of radial symmetry of the piston cylinder. As noted, these compression rings fit within corresponding grooves 52 in the outer periphery 54 of the piston 34 so that the compression rings 50 move up and down with that piston 34 to slide along the cylindrical inner wall surface 56 of the cylindrical passageway 14. Positioned below the compression rings 50 with respect to the cylinder head 16 are one or more oil rings 58. These oil rings 58 also move up and down with the piston 34 but include internal passageways communicating with oil passages 60 through the piston 34 providing a path of lubricating oil from inside the piston 34 through the oil passages 60, and through the oil ring 58 to deliver a film of oil to the inner wall surface 56 of the cylindrical passageway 14 with reciprocating motion 36 of the piston 34.

Referring again to FIG. 1, the present invention may provide one or both of a first and second optical port 62a and 62b through the wall of the cylindrical passageway 14 of the combustion chamber 12. These optical ports 62 allow for the passage of light into and out of the combustion chamber during operation of the engine and maybe associated with one or more optical assemblies 64 providing electrical measurement of the measurement of light absorption by gases within the combustion chamber 12.

Ideally, the optical ports 62 are placed beneath a midpoint between bottom dead center 38 and top dead center 40 such as represent regions of reduced cylinder wear and fouling. Further, the optical ports 62 may be placed generally in a vertical plane aligned with axis 48 representing a location of the cylinder wall having reduced scuffing as a result of the limited rotational freedom of the piston 34 in that plane. Ideally the optical ports 62 are within 45 degrees of this plane measured about an axis of symmetry of the cylindrical passageway 14.

Referring still to FIG. 1, the optical assemblies 64 may be part of a spectroscope 66 operating according to well understood principles to measure absorption line frequencies in light passing through the combustion chamber 12 and in this way to provide quantitative measures both of chemical reaction species and temperatures. In the latter case, temperature may be deduced from the absorption lines of water vapor which change as a function of temperature and may be isolated from other absorption peaks.

The spectroscope 66 may provide, for example, a swept frequency light source using optical assembly 64 whose intensity is measured by a broadband light sensor or may provide a broadband light source with a frequency discriminating sensor or other frequency discriminating mechanism. The invention contemplates other possible spectroscope designs including but not limited to those with optical gratings and filters and the like.

The spectroscope 66 may communicate with an engine controller 70, for example, having a processor 72 and executing a program stored in electronic memory 74 to control the combustion engine 10. In particular, the engine controller 70 may control: the spark plug 32 timing, timing of the valves 24 and 22 (by a cam mechanism not shown), timing of the fuel injector 30, and amount of fuel injected by the fuel injectors 30 during each cycle. Generally, the engine controller will operate using an engine model map 78 defining combinations of these control parameters that will optimize the engine operating state with respect to an objective function of fuel efficiency, power, or emissions as is generally understood in the art.

Referring now to FIGS. 2 and 3, the optical ports 62 are positioned so that with reciprocating motion 36 of the piston 34, the ring pack 42 sweeps across an exposed surface of the optical port 62 to remove fouling deposits and the like. In one embodiment, the optical port 62 presents a light transmissive, disk-shaped window 65 facing into the combustion chamber. The window 65 may have a diameter of less than three millimeters and ideally less than one millimeter and maybe constructed of a robust material such as silica (quartz) or synthetic sapphire. The window 65 may generally be held by press fit, adhesive, or a glass-to-metal bonding technique directly to the cylinder walls or within an insert in the cylinder walls sealed, braised, or otherwise attached.

The inner surface of the light transmissive window 65 may be flush with the inner wall surface 56 of the cylindrical passageway 14 or may be recessed by a recess amount 67 of less than 200 microns and typically less than 150 microns and in some cases less than 50 microns. This recess amount 67 allows cylinder wear (typically as much is 0.5 millimeters) increasing the diameter of the cylindrical passageway 14 with reduced risk that the light transmissive window 65 will protrude from the eroded inner wall surface 56 and be damaged. This recess amount 67 also promotes a protective layer of oil 71 covering the window 65 during initial use such as helps prevent the adhesion of light obscuring particles 73 including partially combusted fuel soot and the like. Motion of the piston ring pack 42 across the window surface dislodges these light-blocking particles and refreshes the oil layer.

The present inventor has determined that current spectroscopy systems can operate through a thin layer of dirty oil 71 holding some light-blocking particles. Such oil 71 will producing an attenuation of less than 20 decibels per window 65 resulting in a total line of sight transmission of at least 100 parts per million sufficient for gas phase absorption spectroscopy.

For a single window system, shown in FIG. 3, having a single optical port 62, an electronic light emitter 75 and electronic light detector 76 may be placed immediately behind the window 65 separated from each other by an isolating opaque spacer 79 to allow light to be injected into the combustion chamber 12 by the light emitter 75 for selective absorption by water vapor and returned for measurement by the light detector 76 which may communicate electronically with spectroscope 66. Separation of the light emitter 75 and light detector 76, while maintaining their axes of sensitivity to be substantially parallel, reduces internal reflection and promotes a measurement of absorption deeper into the combustion chamber 12.

In an alternative design, as shown in FIG. 5, a port system may be used having optical ports 62a and 62b placed in diametric opposition across the combustion chamber 12 along axis 80 parallel to axis 48 (shown in FIG. 1). A similar light emitter 75 and light detector 76 as discussed above may be placed individually behind one of the corresponding windows 65 of these two different optical ports 62a and 62b or, as depicted, a fiber optic cable 82 may lead from each of the optical ports 62a and 62b to communicate light to or from corresponding windows 65. In this case, the fiber optic cables 82 may collect light from or emit light coupled to the window 65, through the interface of lenses 84 and may communicate with either the electronic light emitter 75 or electronic light detector 76 at a remote location.

Referring to FIG. 4, an inwardly exposed face of each window 65 may be given a radius substantially equal to a radius 85 of the cylindrical passageway 14 about its axis of rotational symmetry. In this way, the front surface of the window 65 may be kept as close as possible to the rings 50 and 58 to take advantage of the wiping action provided by those rings to reduce the thickness of any obscuring layer.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” and “a processor” or “spectroscope” and “the processor,” can be understood to include one or more processors or devices that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. An internal combustion engine comprising:
a combustion chamber providing a cylindrical passageway terminating at a cylinder head;
a piston sized to slidably reciprocate within the cylindrical passageway and including at least one piston ring encircling the piston and elastically biased outward to engage inner walls of the cylindrical passageway with movement of the piston; and
at least one window on the inner wall of the cylindrical passageway providing a passage of light into and out of the combustion chamber through the inner wall, an inner surface of the window positioned proximate to the inner surface to be cleared of optically obscuring contamination by movement of the piston ring thereacross with reciprocation of the piston.

2. The internal combustion engine of claim 1 further including a lubrication system delivering oil through openings in the piston to be distributed over the inner wall of the cylindrical passageway and the window with movement of the piston.

3. The internal combustion engine of claim 2 wherein the window is recessed in the inner wall of the cylindrical chamber.

4. The internal combustion engine of claim 3 wherein the window is offset inward by less than 150 micrometers.

5. The internal combustion engine of claim 4 wherein the window is offset inward by less than 50 micrometers.

6. The internal combustion engine of claim 1 further including at least one of an electronic light sensor and electronic light emitter positioned outside of the combustion chamber to receive light through the at least one window.

7. The internal combustion engine of claim 2 further including an optical spectroscope communicating with at least one of the electronic light sensor and electronic light emitter to provide a measure of the optical absorption by gases within the combustion chamber.

8. The internal combustion engine of claim 3 wherein the optical spectroscope measures absorption of water vapor within a temperature range of a combustion engine.

9. The internal combustion engine of claim 1 wherein the optical spectroscope provides a light emitter and a light receiver positioned outside of a single window to project light into the combustion chamber and receive light from the combustion chamber respectively.

10. The internal combustion engine of claim 1 wherein the at least one window includes a first and second window on opposite sides of the inner wall of the cylindrical passageway providing a passage of light into and out of the combustion chamber through the inner wall, the first and second windows positioned proximate to the inner surface to be cleared of contamination by movement of the piston ring thereacross with reciprocation of the piston.

11. The internal combustion engine of claim 1 further including a fuel delivery system for delivering fuel and air into the combustion chamber for ignition therein.

12. The internal combustion engine of claim 11 further including a controller for receiving a measurement from the optical spectroscope to control the fuel delivery system according to a stored program optimizing operation of the internal combustion engine for at least one of fuel efficiency, power, and reduced emissions.

13. The internal combustion engine of claim 1 wherein the window has a diameter of less than three millimeters.

14. The internal combustion engine of claim 1 wherein the window has a surface facing inward to the combustion chamber that is a sector of the cylinder aligned with and conforming to a cylinder defining the cylindrical passageway.

15. The internal combustion engine of claim 1 wherein the window is constructed of a material selected from the group consisting of silica and sapphire.

16. The internal combustion engine of claim 1 wherein the piston provides a piston pin extending along an axis to provide a pivoting joint with a connecting rod communicating between the piston and a crankshaft and wherein the window is positioned on the inner wall of the cylindrical passageway within 45 degrees of a vertical plane of the axis of the piston pin as measured about an axis of symmetry of the cylindrical passageway.

17. The internal combustion engine of claim 1 wherein the piston moves between a top dead center and bottom dead center location during operation and wherein the window is positioned above the bottom dead center location and below a midpoint between the top dead center and bottom dead center positions.
